(19) United States
(12) Patent Application Publication
(10) Pub. No.: US 2007/0082608 A1
(43) Pub. Date: Apr. 12, 2007

(54) Digital multimedia broadcasting system and data processing apparatus and method of broadcasting terminal

(75) Inventor: Youn Ho Nam, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/544,671

(22) Filed: Oct. 10, 2006

Related U.S. Application Data
(60) Provisional application No. 60/724,902, filed on Oct. 11, 2005.

(51) Int. Cl. H04H 7/00; H04B 1/18

(52) U.S. Cl. 455/3.06; 455/186.1

(57) ABSTRACT

Provided is an apparatus for processing data of a broadcasting terminal. The apparatus includes: an element for receiving broadcasting website service contained in digital multimedia broadcasting; an element for storing a received webpage file; an element for analyzing the received webpage file and providing the analyzed webpage file to a subscriber; an element for selecting a predetermined media entity contained in the received webpage file; and an element for transmitting the selected media entity to a counter party's terminal.

### BACKGROUND OF THE INVENTION

1. Field of the Invention

The present invention relates to a digital multimedia broadcasting system and data processing apparatus and method of a digital multimedia broadcasting system terminal.

2. Description of the Related Art

Due to development of a mobile communication technology, a portable terminal provides short message service (SMS) for transmitting and receiving a text of a short sentence as well as voice communication service.

The short message service transmits data including characters or numbers using a portable terminal or a network. Even when a portable terminal is turned off or a subscriber is located in an out-of-service region, transmission of a message is repeatedly tried until communication become possible. That is, SMS is simple electronic mail (e-mail) service developed for complement a disadvantage of a portable terminal having reduced communication quality.

Also, a message transmitted from a portable terminal passes through a base station or an access point, and is stored in a short message center (SMC), and then transmitted to a reception terminal.

A utilization range of such a portable terminal extends from communication with a counter part through a text or voice to various information providing service and a payment means of electronic commerce.

Also, a function of a portable terminal gradually gets out of character-oriented service and evolves into multimedia message service (MMS) capable of transmitting and receiving photos, pictures, and moving images.

Also, digital audio broadcasting (DAB) or digital multimedia broadcasting (DMB) is mobile multimedia broadcasting capable of providing high quality image service on a screen anywhere and anytime while moving in high speed as well as providing various additional data service such as compact-disk level high quality audio service, traffic service, and securities compared to related art analog AM or FM broadcasting. Accordingly, it is expected that the DAB or DMB not only replaces current AM and FM broadcasting but also is in the limelight as new mobile multimedia service.

### SUMMARY OF THE INVENTION

Accordingly, the present invention is directed to a digital multimedia broadcasting system and data processing apparatus and method of a broadcasting terminal that substantially obviate one or more problems due to limitations and disadvantages of the related art.

An object of the present invention is to provide broadcast website service (BWS) in a digital multimedia broadcasting system.

Another object of the present invention is to provide data processing apparatus and method of a digital multimedia broadcasting system terminal, allowing broadcasting website service of a digital multimedia broadcasting system to transmit a message to a predetermined reception party using a broadcasting interface.

A further another object of the present invention is to provide data processing apparatus and method of a digital multimedia broadcasting system terminal, capable of transmitting a predetermined entity on broadcasting website service received at a reception terminal to other reception party.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a data processing apparatus of a broadcasting terminal in a digital multimedia broadcasting system, the apparatus including: an element for receiving broadcasting website service contained in digital multimedia broadcasting; an element for storing a received webpage file; an element for analyzing the received webpage file and providing the analyzed webpage file to a subscriber; an element for selecting a predetermined media entity contained in the received webpage file; and an element for transmitting the selected media entity to a counter party's terminal.

In another aspect of the present invention, there is provided a data processing apparatus of a broadcasting terminal in a digital multimedia broadcasting system, the apparatus including: an element for displaying a webpage file received via broadcasting website service; an element for selecting a media entity contained in the displayed webpage file; and an element for transmitting the selected media entity to a reception party using an identification data of the reception party.

In a further another aspect of the present invention, there is provided a data processing method of a broadcasting terminal, the method including: receiving broadcasting website service contained in the digital multimedia broadcasting; analyzing and storing a received webpage file, and providing the analyzed webpage file to a subscriber; selecting a predetermined media entity contained in the received webpage file; and transmitting the selected media entity using an identification data of a counter party's terminal.

In a still further another aspect of the present invention, there is provided a data processing method of a broadcasting terminal, the method including: displaying a webpage file received via broadcasting website service; selecting a media entity contained in one of the displayed webpage and a webpage file; and transmitting one of the selected webpage and media entity to a reception party using an identification data of the reception party.

In a yet further another aspect of the present invention, there is provided a data processing method of a broadcasting terminal, the method including: receiving a message containing a media entity; storing and informing the received message; and when a subscriber selects the received message, displaying a corresponding media entity.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a construction of a digital multimedia broadcasting system according to an embodiment of the present invention;

FIG. 2 is a detailed view illustrating a construction of a digital multimedia broadcasting system according to an embodiment of the present invention;

FIG. 3 is a view illustrating an example of audio data transmission in broadcasting website service according to an embodiment of the present invention;

FIG. 4 is a view illustrating an example of video data transmission in broadcasting website service according to an embodiment of the present invention;

FIG. 5 is a view illustrating an example of image data transmission in broadcasting website service according to an embodiment of the present invention;

FIG. 6 is a view illustrating a transmission format of a media entity in broadcasting website service according to an embodiment of the present invention;

FIG. 7 is a flowchart illustrating data processing at a broadcasting terminal according to an embodiment of the present invention;

FIG. 8 is a view illustrating a method for processing audio or video data at a broadcasting terminal according to an embodiment of the present invention;

FIG. 9 is a flowchart illustrating a method for processing image data at a broadcasting terminal according to an embodiment of the present invention; and

FIG. 10 is a flowchart illustrating a method for processing data at an image data receiving terminal according to an embodiment of the present invention.

### DETAILED DESCRIPTION OF THE INVENTION

Reference will now be made in detail to the preferred embodiments of the present invention, examples of which are illustrated in the accompanying drawings.

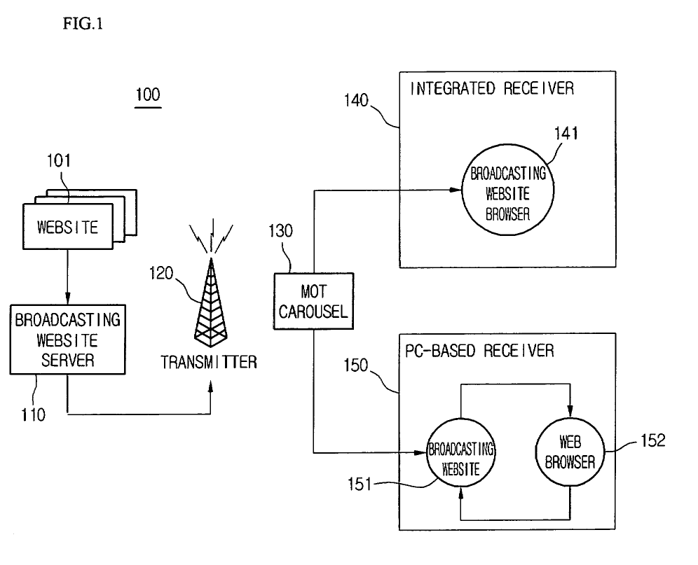

FIG. 1 is a view illustrating a digital multimedia broadcasting system according to an embodiment of the present invention.

Referring to FIG. 1, the digital multimedia broadcasting (DMB) system 100 includes a transmission party and a reception party. The transmission party is an apparatus for transmitting DMB, and the reception party is a terminal (e.g., a DMB terminal) for receiving at least DMB.

The DMB system 100 transmits data via a DMB or DAB network. In the case where the DMB system 100 transmits data via the DMB or DAB network, the data is transmitted using a carousel standard 130 of a multimedia object transfer (MOT) protocol. Data coded at the transmission party can be repeatedly transmitted according to the carousel standard when needed. Also, these data can be converted into an Internet protocol (IP) form and then transmitted according to a standard of each broadcasting system.

Here, DMB is broadcasting service provided to a reception terminal (e.g., a fixed, portable terminal, or a terminal for a vehicle), for modulating various multimedia signals such as voices and images into digital data, and transmitting the same. Also, a digital multimedia broadcasting system is based on a DAB technology and adds multimedia broadcasting concept to the DAB to additionally transmit data information such as moving images, weather data, news, and position data. Also, even while a subscriber moves, the subscriber can receive broadcasting of CD and DVD-level high quality sound and image using a portable terminal or a terminal for a vehicle.

The transmission party transmits a webpage to the MOT carousel 130, and includes a website 101, a broadcasting website server 110, and a transmitter 120. The reception party receives broadcasting website service via the MOT carousel 130, and roughly includes an integrated receiver 140 and a personal computer (PC)-based receiver 150.

The website 101 at the transmission party provides service contents in a webpage form, and the broadcasting website server 110 converts data of a webpage format into data of a transmission format, and transmits the data via the transmitter 120. Here, the transmitter 120 includes at least a digital multimedia broadcasting network.

Here, for data transmission and reception, the digital multimedia broadcasting system provides broadcast website service (BWS). The BWS provides service in a webpage form using a MOT protocol.

The broadcasting website service receives and stores all files related to a website in advance using the receiver, and provides the files to a subscriber. Also, the broadcasting website service stores in advance the files related to the website, that is, the files contained in a webpage, so that a subscriber can receive web service in a form similar to Internet web service even without a reverse channel.

The integrated receiver 140 analyzes a webpage creating language (e.g., HTML, xml, sgml) constituting a website's file and directly displays the same on a display device (not shown) using a broadcasting website browser 141. Here, the webpage's file may include other language, e.g., java class code, css, asp, and php as well as the webpage creating language such as HTML. Also, a web browser using a java language (code) can be used.

The PC-based receiver 150 decodes and delivers only received data of the broadcasting website 151, and displays a webpage using a web browser 152 installed in a PC.

For this purpose, the PC-based receiver 150 is used to designate a webpage's logic address (e.g., URL) on a screen of a web browser using HTML used for transmitting and receiving data such as a file between the website server 110 and the receivers 140 and 150 under a client/server environment. The URL has the following format. For example, the URL can be designated like http://host name/absolute path. The present invention can use a standardized logic address for displaying various resources such as a file and a new group on a webpage with respect to a webpage's file.

Since all websites exist within service in the broadcasting website, the host_name does not need to be used. P positions of all entities contained in a website or a webpage represent relative positions within the service on an absolute_path portion.

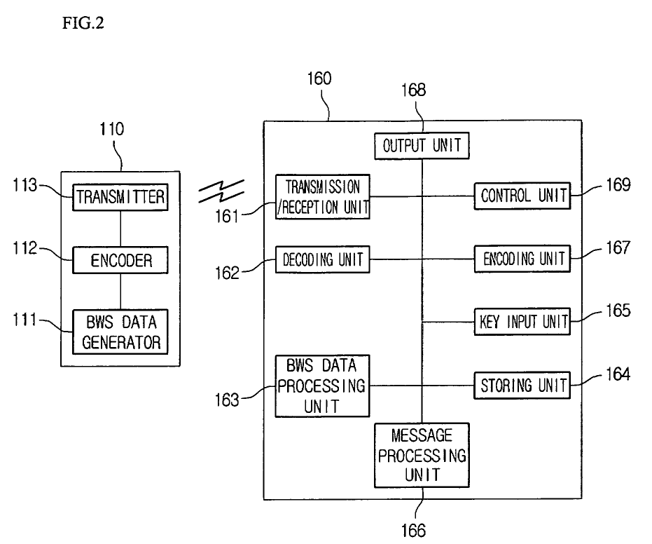

FIG. 2 is a detailed view illustrating a construction of a digital multimedia broadcasting system according to an embodiment of the present invention.

Referring to FIG. 2, the broadcasting website server 110 includes a BWS data generator 111, an encoder 112, and a transmitter 113. The BWS data generator 111 generates data provided from websites or data made by the BWS data generator 111 into BWS data, and the encoder 112, which is an orthogonal frequency division modulation (OFDM) encoder, for example, encodes the generated BWS data appropriately for a transmission format that can be received by the receiver. The transmitter 113 modulates the encoded BWS data and transmits the encoded BWS data via a transmission antenna. By doing so, the digital multimedia broadcasting system can provide broadcasting website service.

A plurality of files are linked to each other in a webpage for the broadcasting website service. These links are expressed as URLs on the webpage, the broadcasting website server designates the URL in files to be transmitted to the MOT carousel, and the receiver can obtain a webpage file or an entity corresponding to an Internet address via a corresponding linked URL.

Also, the receiver 160 (e.g., a DMB terminal) can receive digital multimedia broadcasting signals, and includes a transmission/reception unit 161, a decoding unit 161, a BWS data processing unit 163, a storing unit 164, a key input unit 165, a message processing unit 166, an encoding unit 167, an output unit 168, and a control unit 169. The transmission/reception unit 161 modulates/demodulates signals transmitted/received via the antenna, and receives BWS data via broadcasting website service transmitted from a server.

The decoding unit 162 of the receiver 160, which is an OFDM decoder, for example, decodes received BWS data into original data. The decoded BWS data is analyzed by the BWS data processing unit 163 and stored in the storing unit 164 in advance. At this point, a corresponding initial page of the analyzed broadcasting website is displayed through a display unit, which is the output unit 168. Through this, broadcasting web service can be provided. The decoding unit 162 decodes a message or data received via a mobile communication system of code division multiple access (CDMA). A decoder can be provided to a separate CDMA module.

Here, the BWS data processing unit 163 is a decoder of a web browser. Since the PC-based receiver has a standard web browser installed by a user, data from the MOT carousel is converted into data that is readable by the standard web browser. However, since the integrated receiver has no standard web browser, the integrated receiver performs functions of HTML decoding, expressing, MOT carousel decoding. That is, the receiver 160 includes a BWS decoder function and a browser function for allowing a webpage to be displayed for broadcasting website service.

The receiver 160 can include internal elements roughly divided into two parts of a DMB module and a CDMA module, and elements such as an output unit to be used in common as a common module.

Various media entities such as audio entities (MPEG-1, MPEG-2 Layer3, and MPEG-2 AAC), video entities (MPEG-2 and MPEG-4), and images (jpeg, png, and mng) as well as characters are selectively inserted into a webpage provided via the broadcasting website service, appropriately for each webpage's characteristic and provided to a subscriber. Here, image entities include still images and sliding images.

When a webpage is serviced to the receiver 160, a subscriber can select a predetermined media entity, for example, one of an audio entity, a video entity, and an image entity contained within the webpage. The selected one or more image entities can be transmitted to a counter party's terminal via a mobile communication network by the counter party's identification data (e.g., phone number). Here, at least one media entity can be selected and can include media entities of kinds different from each other (e.g., audio and video).

For this purpose, the selected media entity, a counter party's identification data, and a send item are displayed on a screen for transmitting an image entity. Here, when the media entity is an image entity, a URL designating an image entity or a corresponding still image entity can be displayed. The counter party's identification data can include a number, an IP address of the counter party's terminal, a website's address, and an e-mail address. Also, when the media entity is an audio or video entity, the media entity can be linked to a URL designating a corresponding audio or video, or can be a corresponding media entity. The counter party's identification data can include a number, an IP address of the counter party's terminal, a website's address, and an e-mail address.

Also, the media entity can be inserted into a message transmission format by selecting a media entity provided on a webpage, or inserted into the message transmission format by calling a media entity stored in the storing unit 164. Also, a subscriber can directly insert other media entity on the message transmission format.

After a predetermined image entity is selected and the counter party's identification data are input, the message processing unit 166 processes a transmission message using a format to be transmitted. Here, the transmission message can be provided in the form of an SMS.

Also, the key input unit 165 is designed for inputting service selection and a phone number.

The encoding unit 167 encodes a message processed by the message processing unit 166, the transmission/reception unit 161 modulates the message, and the message is transmitted via a mobile communication system network. The output unit 168 includes a display part and a voice output part to output voices and video signals. Also, the control unit 169 controls each parts of the system to control service selection, transmission/reception of a message.

Meanwhile, a broadcasting gateway interface is provided on a webpage provided through broadcasting website service so that a subscriber can select a webpage and control or access entities contained in the webpage like tuning of the receiver, service selection, and a volume control on the web browser. Here, the broadcasting gateway interface is a DGI, which can have a URL of the same type as common gateway interface (CGI).

DGI functions are similar to CGI functions but are not performed at a server. The DGI functions are defined in advance and performed at the receiver. That is, the receiver supports the DGI functions in itself. These DGI functions are separately stored in a predetermined directory such as a “/dgi-bin/”. When a subscriber calls the function using a URL, the receiver performs the corresponding function. Also, media entities collected from a webpage are stored in the directory or a directory that can be discriminated.

A URL for executing the DGI function has the following form: /dgi-bin/select_service?service_id=“12345”.

Here, “select_service” is intended for selecting a kind of service, and “service_id” stands for an actual service entity in a selected service.

When the DGI function is performed, the receiver automatically traces other URL in order to select new service. The directory in which the DGI functions are present should be separately managed so that the directory does not overlap a directory in which other MOT entities are present. Therefore, other MOT entities do not use content names of a type such as a “/dgi-bin/”.

Also, for reproduction and control of digital multimedia broadcasting service, a kind of service is selected through service selection. An example of syntax used for selecting desired service is as follows: /dgi-bin/select_service?service=LOCATOR.

Here, for reproduction and control of DMB service, LOCATOR is required for designating DMB service and a service component. An example of a type can be defined as follow.

Service:

dmb://receiveAddress.ensembleId.serviceId

service component:

dmb://receiverAddress.ensembleId.serviceId.componentId

In the case where the DMB receiver includes a plurality of tuners therein, “receiverAddress” denotes a predetermined tuner. “ensembleId” is data for identifying an ensemble, which a bundle of broadcasting services and data services transmitted when a broadcasting frequency is selected. “serviceId” is service identification data, and “componentId” is service component identification data.

When the service selection and the locator are provided, service is provided through a corresponding webpage provided by broadcasting website service.

A subscriber can select a media entity such as audio, video, an image, or still image entity contained in the webpage. The selected media entity can be transmitted to a counter party (a counter party's terminal and a server). In other words, files of media entities among various resources contained in the webpage are stored in advance, so that data can be transmitted to other counter party using the stored media entities. Here, the media entities are resources that can be expressed on the Internet and include file data such as texts, images, videos, and audios.

A transmission operation of a message service broadcasting gateway interface having a function of transmitting media entities provided by the broadcasting website service will be described below. Transmission operations of an audio message service (AMS) DGI, a video message service (VMS) DGI, an image message service (IMS) DGI will be described below.

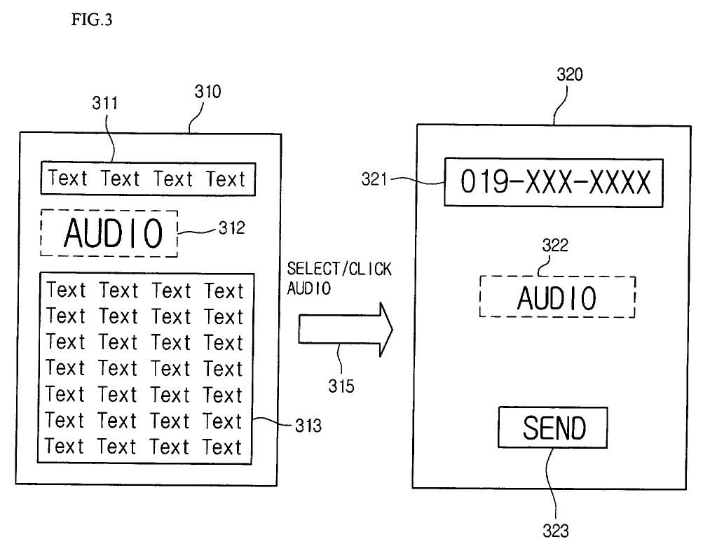

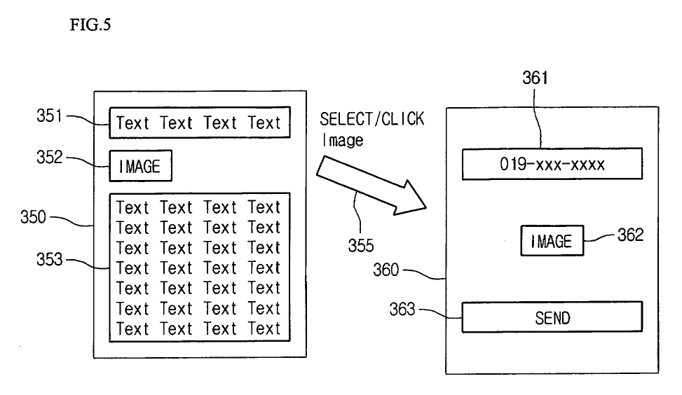

FIGS. 3 and 5 are views illustrating an example where a terminal according to the present invention transmits a media entity on broadcasting website service.

FIG. 3 is a view illustrating an example of a transmission operation of an AMS entity according to an embodiment of the present invention.

Referring to FIG. 3, a broadcasting website service screen 310 can include text regions 311 and 313, and an audio region 312 in predetermined portions of the screen. When a subscriber selects/clicks (315) an audio entity contained in the audio region 312, a message transmission screen 320 is displayed. The message transmission screen 320 includes a counter party identification data input item 321, an audio entity 322, and a send item 323. When the subscriber selects the send item 323 with this screen state, the audio entity is transmitted according to counter party identification data.

An example of an AMS transmission operation will be described below.

Here, an example of syntax used for transmitting AMS to a number designated by a subscriber is as follows: /dgi-bin/send_vms?telnum=TELNUM&ams_body=AUDIO.

Here, “TELNUM” is a phone number to which AMS is to be transmitted and uses a form defined in a Tel RUL[II-8]. “AUDIO” designates contents of AMS or related contents. “ams_body” can be omitted. In this case, an ams editor (not shown) is used. That is, “AUDIO” can designate a selected audio entity. In the case where an audio entity is omitted and not selected, a subscriber can select and use a separately stored audio entity. In this case, an edited audio file is designated using an audio editor (ams editor).

When a terminal that does not support AMS uses the DGI, an error is displayed.

Also, an example of a method for transmitting broadcasting website service received by a terminal to other terminal will be described below. When a subscriber selects a predetermined AMS entity in order to transmit one or more AMS entities contained in a predetermined webpage of a BWS received by the terminal, a screen for designating the selected AMS entity and a phone number item of other terminal is provided.

For this purpose, when a predetermined AMS entity is selected, /dig-bn/send_ams?telnum=TELNUM&ams_body=AUDIO occurs. By this syntax, a transmission screen is provided.

Also, when a send command is input in order to transmit the selected AMS entity, data(/dig-bn/send_ams?telnum=TELNUM&sms_body=AUDIO) generated by the syntax is converted into data of a format conforming to a message transmission protocol (e.g., IS-637-A protocol), a base station of a mobile communication network is accessed, and data to be transmitted using a mobile communication protocol (e.g., CDMA protocol) is created and transmitted. At this point, when the data corresponding to the mobile communication protocol is created, (audio, voice) is selected from a service option. According to the present invention, an audio entity provided on a webpage is converted into a message format of a mobile communication network and can also be transmitted to other terminal in a multimedia broadcasting system.

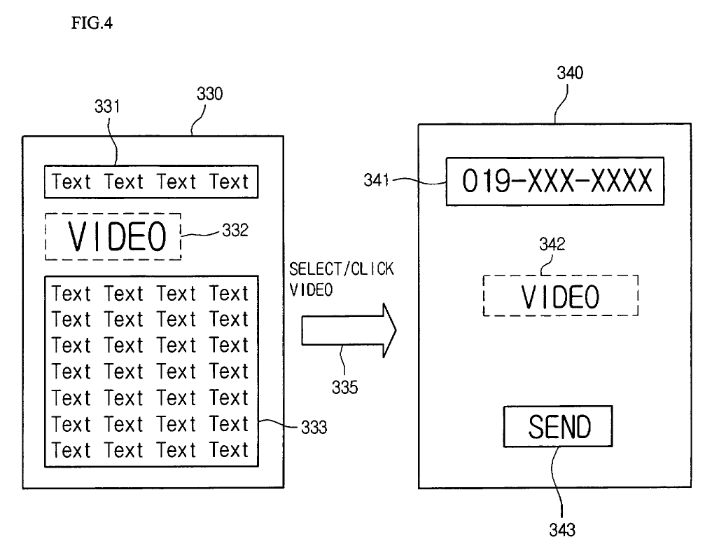

FIG. 4 is a view illustrating an example of a transmission operation of a VMS entity according to an embodiment of the present invention.

Referring to FIG. 4, a broadcasting website service screen 310 can include text regions 331 and 333, and a video region 332 in predetermined portions of the screen. When a subscriber selects/clicks (335) a video entity contained in the video region 332, a message transmission screen 340 is displayed. The message transmission screen 340 includes a counter party identification data input item 341, a selected video entity 342, and a send item 343. When the subscriber selects the send item 343 with this screen state, the video entity 342 is transmitted according to counter party identification data.

The VMS transmission operation will be described below.

Here, an example of syntax used for transmitting VMS to a number designated by a subscriber is as follows:

/dgi-bin/send_vms?telnum=TELNUM&vms_body=VIDEO

Here, “TELNUM” is a phone number to which VMS is to be transmitted and uses a form defined in a Tel RUL[II-8]. “VIDEO” designates contents of VMS or related contents. “vms_body” can be omitted. In this case, a vms editor (not shown) is used. “VIDEO” includes an image, for example, a moving image file. “VIDEO” can designate a selected video entity. In the case where the video entity is omitted and not selected, a subscriber can select and use a separately stored video entity. In this case, an edited video file is designated using a video editor.

When a terminal that does not support VMS uses the DGI, an error is displayed.

Also, an example of a method for transmitting broadcasting website service received by a terminal to other terminal will be described below. When a subscriber selects a predetermined VMS entity in order to transmit one or more VMS entities contained in a predetermined webpage of a BWS received by the terminal, a screen for designating the selected VMS entity and a phone number item of other terminal is provided.

For this purpose, when a predetermined VMS entity is selected, /dig-bn/send_vms?telnum=TELNUM&vms_body=VIDEO occurs. By this syntax (or function), a transmission screen is provided.

Also, when a send command is input in order to transmit the selected VMS entity, data(/dig-bn/send_vms?telnum=TELNUM&sms_body=VIDEO) generated by the syntax is converted into data of a format conforming to a message transmission protocol (e.g., IS-637, more specifically, IS-637-A protocol), a base station of a mobile communication network is accessed, and data to be transmitted using a mobile communication protocol (e.g., CDMA protocol) is created and transmitted. At this point, when the data corresponding to the mobile communication protocol is created, (video, moving image) is selected from a service option. According to the present invention, a video entity provided on a webpage is converted into a message format of a mobile communication network and can also be transmitted to other terminal in a multimedia broadcasting system.

FIG. 5 is a view illustrating an example of a transmission operation of an IMS entity according to an embodiment of the present invention.

Referring to FIG. 5, a broadcasting website service screen 350 can include text regions 351 and 353, an image region 352, and other media entity in predetermined portions of the screen. When a subscriber selects/clicks (355) an image entity contained in the image region 352, a message transmission screen 360 is displayed. The message transmission screen 360 includes a counter party identification data input item 361, a selected image entity 362, and a send item 363. When the subscriber selects the send item 363 with this screen state, the image entity 362 is transmitted according to counter party identification data.

The IMS transmission operation will be described below.

Here, an example of syntax used for transmitting IMS to a number designated by a subscriber is as follows:

/dgi-bin/send_ims?telnum=TELNUM&ims_body=IMAGE

Here, “TELNUM” is a phone number to which IMS is to be transmitted and uses a form defined in a Tel RUL[II-8]. “IMAGE” designates contents of IMS or related contents. “ims_body” can be omitted. In this case, an ims editor (not shown) is used. “IMAGE” includes a still image and an image file. “IMAGE” can designate a selected image entity. In the case where the provided image entity is not selected, a subscriber can select and use a separately stored image entity. In this case, a separate image editor is used.

When a terminal that does not support IMS uses the DGI, an error is displayed.

Also, an example of a method for transmitting broadcasting website service received by a terminal to other terminal will be described below. When a subscriber selects a predetermined IMS entity in order to transmit one or more IMS entities contained in a predetermined webpage of a BWS received by the terminal, a screen for designating the selected IMS entity and a phone number item of other terminal is provided.

For this purpose, when a predetermined IMS entity is selected, /dig-bn/send_ims?telnum=TELNUM&ims_body=IMAGE occurs. By this syntax (or function), a transmission screen is provided.

Also, when a send command is input in order to transmit the selected IMS entity, data(/dig-bn/send_ims?telnum=TELNUM&ims_body=IMAGE) generated by the syntax is converted into data of a format conforming to a message transmission protocol (e.g., IS-637-A protocol), a base station of a mobile communication network is accessed, and data to be transmitted using a mobile communication protocol (e.g., CDMA protocol) is created and transmitted. At this point, when the data corresponding to the mobile communication protocol is created, “image” is selected from a service option. According to the present invention, an image entity provided on a webpage is converted into a message format of a mobile communication network and can also be transmitted to other terminal in a multimedia broadcasting system.

When the VMS, AMS, or IMS are transmitted, a terminal's phone number, a website address, and an IP address can be selectively included as a counter party's identification data. The counter party's identification data may be data directly input by a subscriber or include data linked to each media entity.

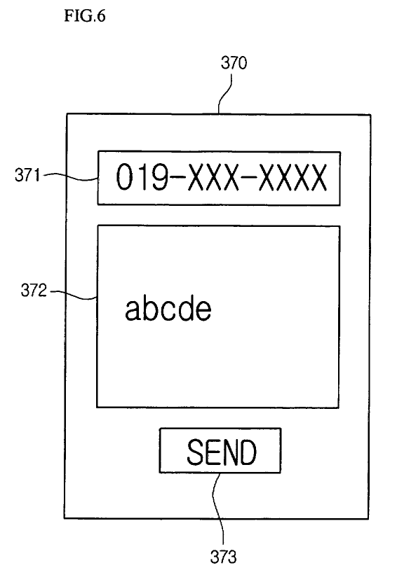

FIG. 6 is a view illustrating a transmission message screen format according to an embodiment of the present invention. Referring to FIG. 6, a message transmission screen 370 includes at least a counter party's identification data 371, selected service (text/audio/video/image) entity data 372, and an interface 373 allowing a subscriber to make an access such as a send. Here, the interface 373 includes a DGI used when the message transmission screen 370 for a media entity (audio/video/image) is formed on a web browser.

When the media entity is transmitted, an actual stream included in the media entity can be transmitted. At this point, the media entity and a URL corresponding to the media entity can be also contained and transmitted by a packet unit.

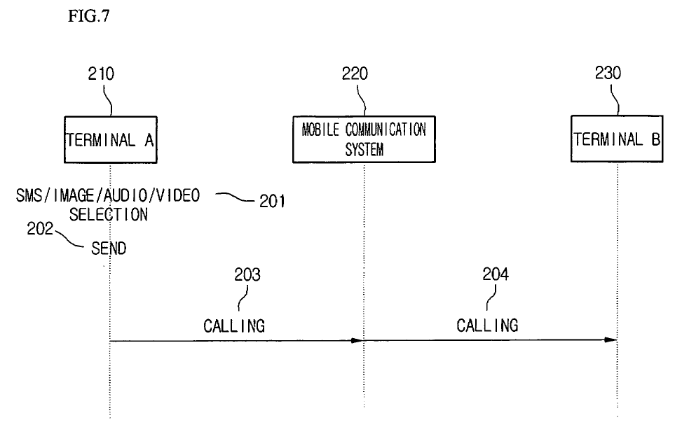

FIG. 7 is a view illustrating an example of transmitting a message at a broadcasting terminal according to an embodiment of the present invention.

Referring to FIG. 7, a terminal A 210 selects a media entity 201 such as SMS, voice, video, and image on broadcasting website service (201), and selects a send on a message transmission screen with respect to the selected media entity to transmit a message containing the media entity (202). At this point, the transmitted message is transmitted to a terminal B (230), which is a counter party's terminal, via a mobile communication system 220 (203 and 204).

Here, the terminal A can transmit a message to one or more reception terminals, or server, or a website when transmitting a message.

The mobile communication system 220 includes a base station, an exchange, and a message center, and uses a CDMA protocol so that mobile communication can be performed between terminals. For example, data is transmitted and received between the terminal A and the base station, the base station and exchange associated with the terminal A, the exchange, the base station of the terminal B, and the terminal B using a predetermined channel including a CDMA protocol. Also, a service option of a message provided by the mobile communication system includes transmission of data such as an SMS, audio, video, and image. Created message is transmitted/received in the form of a data burst message. The exchange includes SMS/Multi-media Message Service (MMS) and can communicate with the message center and the server, and can cooperate with other network.

The terminal A transmits the message to the base station via an access channel/traffic channel depending on a length of a data burst message. The counter party′ terminal B receives the message via a paging channel/traffic channel and a corresponding base station.

Here, the access channel is a wireless control channel used when the terminal accesses the system, and means a control channel for the system access. The control channel is a reverse CDMA channel a mobile station (terminal) uses in order to communicate with the base station. The traffic channel is designed for transmitting/receiving data, and the paging channel is a wireless control channel used when the terminal is called. The paging channel is a forward control channel (FCC) used for calling a counter party's terminal (i.e., a mobile station) or transmitting a command.

Also, IS-637-A used as the message transmission protocol is designed for transmitting an SMS, and the CDMA protocol performs only a link layer role to carry out bearer service. The CDMA protocol is classified into a synchronous CDMA protocol and an asynchronous CDMA protocol, and can include CDMA2000 1x and IS-95 series. A hand shaking procedure of message transmission is performed at an L2 layer of the CDMA protocol (e.g., CDMA 2000 1x).

Here, a protocol associated with the message transmission is defined at TIA/EIA/IS-637, and complemented contents are defined at TSB79. That is, the protocol can be realized using a protocol defined in TIA/EIA Technical Specification IS-41C (SP3588), IS-637(CDMA).

A data burst message is made using such a protocol regardless of SMS/AMS/VMS/IMS, and conveyed on the CDMA protocol and transmitted. Though not shown, the protocol's stacks include at least a tele-service layer, a transport layer, a relay layer, and a link layer.

The data burst message is defined in a standardization group 3GPP2 of CDMA2000 as illustrated in Table 1.

TABLE 1

| Field | Length (bits) |
|---|---|
| MSG_NUMBER | 8 |
| BURST_TYPE | 6 |
| NUM_MSGS | 8 |
| NUM_FIELDS | 8 |

“MSG_NUMBER” is a message number existing within a data burst stream, and “BURST_TYPE” is a data burst type and is defined in TSB58-A. “NUM_MSGS” is a number of a message within a data burst stream, and “NUM_FIELDS” is the number of characters contained in this message.

Also, the origination message is defined in a standardization group 3GPP2 of CDMA2000 as illustrated in Table 2.

TABLE 2

| Field | Length (bits) |
|---|---|
| MOB_TERM | 1 |
| SLOT_CYCLE_INDEX | 3 |
| MOB_P_REV | 8 |
| SCM | 8 |
| REQUEST_MODE | 3 |
| SPECIAL_SERVICE | 1 |
| SERVICE_OPTION | 0 or 16 |
| PM | 1 |
| DIGIT_MODE | 1 |
| NUMBER_TYPE | 0 or 3 |
| NUMBER_PLAN | 0 or 4 |
| MORE_FIELDS | 1 |
| NUM_FIELDS | 8 |

“MOB_TERM” is an approval indicator of mobile terminal calls, “SLOT_CYCLE_INDEX” is a slot cycle index, and “MOB_P_REV” is a protocol revision of a mobile station. “SCM” is a station class mark, “REQUEST_MODE” is a requested mode code, “SPECIAL_SERVICE” is a special service option indicator, and “SERVICE_OPTION” is a requested service option for an origination message. “PM” is a privacy mode indicator, “DIGIT_MODE” is a digit mode indicator, “NUMBER_TYPE” is a type of a number, “NUMBER_PLAN” is a numbering plan, and “MORE_FIELDS” is a more dialed digits indicator. Also, “NUM_FIELDS” is a number of a digital dialed in this message.

In a service option of the origination message, a predetermined data kind can be designated as 0 or 16 bits depending on a data kind of SMS, AMS, VMS, and IMS. Examples of the service option include a video codec, an audio codec, and an image compression type (JPEG, PNG, and GIF). A compression type of a media entity contained in a terminal can be informed to a counter party's terminal, so that reproduction of a media can be performed more easily.

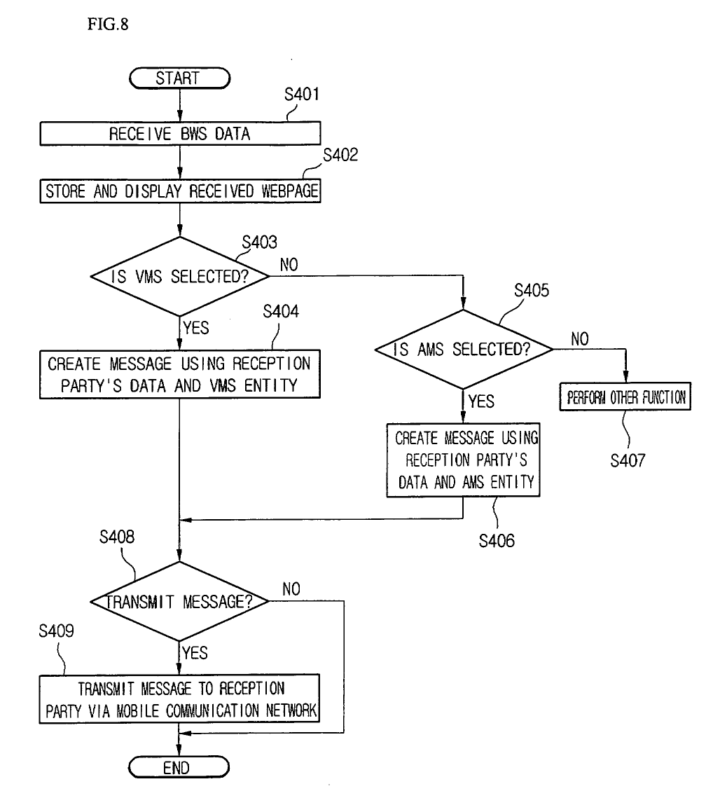

FIG. 8 is a view illustrating a flowchart of a method for processing AMS/VMS data at a broadcasting terminal according to an embodiment of the present invention.

Referring to FIG. 8, data of a broadcasting website service is received (S401), and a webpage of a received website is analyzed, stored, and displayed on a screen (S402).

At this point, whether a media entity, e.g., a VMS entity is selected or AMS entity is selected by a subscriber from entities provided on the webpage is checked (S403 and S405).

When the VMS entity is selected as a result of the checking, a message is created using data of the reception party and the selected VMS entity (S404). When the AMS entity is selected as a result of the checking, a message is created using data of the reception party and the selected AMS entity (S406). When a media entity is not selected as a result of the checking, other function is performed (S407).

After that, whether to transmit the created message is checked (S408). When a message transmission is selected as a result of the checking, the message is transmitted to the reception party via a mobile communication network using the reception party's data (S409). Here, the message transmitted to the reception party can also include a selected media entity, data of a called party, and data of a calling party. Also, when the message includes the data of the calling party, the data can be included automatically or manually.

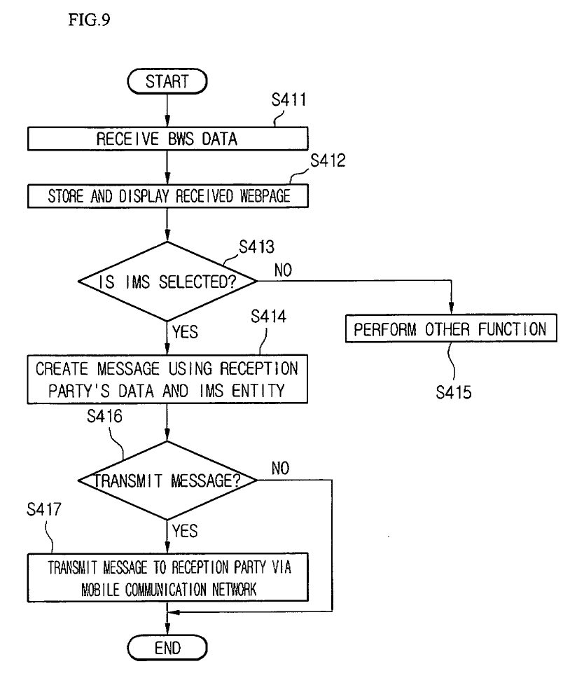

FIG. 9 is a flowchart illustrating a method for processing IMS data at a broadcasting terminal according to an embodiment of the present invention.

Referring to FIG. 9, data of broadcasting website service is received (S411), and a webpage of a received website is analyzed, stored, and displayed on a screen (S412).

At this point, whether a media entity, e.g., an IMS entity is selected by a subscriber from entities provided on the webpage is checked (S415). When the media entity is not selected, other function is performed (S415).

When the IMS entity is selected as a result of the checking, a message is created using the data of the reception party and the selected IMS entity (S414), and whether to transmit the created message is checked (S416). When a message transmission is selected as a result of the checking, the message is transmitted to the reception party via a mobile communication network using the reception party's data (S417). Here, the message transmitted to the reception party can also include a selected media entity, data of a called party, and data of a calling party. Also, when the message includes the data of the calling party, the data can be included automatically or manually.

Also, according to the present invention, a subscriber's opinion regarding a media entity such as audio, video, and an image selected on the message transmission screen can be additionally input and transmitted together. That is, the subscriber's opinion includes the subscriber's remark regarding the media entity or contents the subscribe desires to deliver to a counter party. Also, the selected image entity and a corresponding text on the webpage can be transmitted together.

In the present invention, only one of media entities on the webpage is selected or a media entity directly edited by the subscriber is conveyed on a message and transmitted together. Also, a webpage file itself or a BWS file itself can be conveyed on a message and transmitted together.

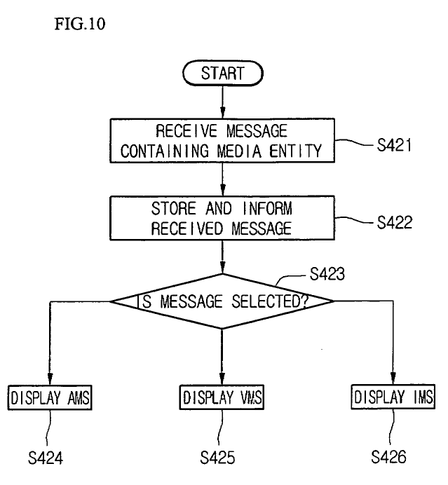

FIG. 10 is a flowchart illustrating a method for processing a received message at a receiving terminal according to an embodiment of the present invention.

A data burst message is received via a base station of a mobile communication system (S421). The data burst message includes a media entity.

Also, the received message is stored, and reception of the message is informed of to a terminal's subscriber (S422).

When a selection request for the message is made by the subscriber (S423), a message containing a corresponding media entity is displayed. For example, when the corresponding media entity is an AMS entity, an audio entity is displayed (reproduced) together with a counter party's identification data (S424). When the corresponding media entity is a VMS entity, a video entity is displayed (reproduced) together with a counter party's identification data (S425). Also, when the corresponding media entity is an IMS entity, an image entity is displayed (reproduced) together with a counter party's identification data (S426).

Also, in the case where the reception terminal supports a DGI function and the received media entity contains a URL, when a displayed (reproduced) media entity is selected, a corresponding URL can be accessed. Also, a message can be retransmitted to a counter party's terminal in the same manner as in the transmitter. Also, when the media entity is selected, an interface such as reproduction and stop can be provided to a reproducible media entity, i.e., an audio or video entity.

Also, in the case where a terminal of the transmission party conveys a webpage file itself or a BWS file itself on a message and transmits the message via a mobile communication system, a terminal of the reception party receives the webpage file or the BWS file itself and stores an entity of the webpage in a memory. After that, the terminal of the reception party informs a subscriber of message reception. The webpage file or the BWS file itself is operated as a popup by the subscriber's selection, so that the webpage file or the BWS file can be displayed on the reception party's terminal in almost the same configuration as that seen by the transmission party.

For another embodiment of the present invention, the media entity contained in the broadcasting website service received in the terminal can be also transmitted to other terminal, and other function can be added using the webpage.

For example, the present invention can be applied to the case of transmitting a subscriber's reaction to an image entity contained in broadcasting website service received by the terminal to a broadcasting station or a related server.

When a subscriber intends to purchase clothes of an actor while the clothes of the actor appearing in a drama on the air are provided in the form of moving images such as MPEG4, MPEG2, and H.264 via BWS, data such as a website address of a home shopping company providing data regarding the actor's clothes are linked to the clothes, so that when the subscriber selects the actor's clothes, the website address can be accessed. Here, the data regarding the home shopping company includes at least one of a phone number, an address of a home shopping broadcasting station, and an address of a home shopping site.

Also, the present invention can be applied to the case where an audience rating is surveyed while a program on the air is provided as moving image via BWS. That is, the present invention can be utilized in various ways using link data of each media entity contained in a webpage. For example, a place appearing in a drama is linked, so that a corresponding site or company can be connected.

To allow a corresponding website to be accessed using link data of each entity of a webpage, “locator” can be designated to a URL instead of “TELNUM” in a syntax. That is, instead of telnum=TELNUM, locator=URL.

Also, in the case where an audience rating is surveyed while a program on the air is provided as moving images via BWS, a telephone number of a broadcasting station or a URL of an audience rating surveying organization's server can be designated for “TELNUM”. In this case, when a menu regarding viewing/hearing within BWS is selected, data regarding viewing/hearing is transmitted to a server of a broadcasting station or an audience rating surveying organization's server.

For reference, a broadcasting website intermediate profile standard supports content types expressed as multi-purpose Internet mail extensions (MIME).

According to the present invention, a use efficiency of BWS in a digital multimedia broadcasting system can improve.

According to the present invention, a broadcasting terminal allows an entity to be transmitted to other terminal on BWS, so that use of the terminal increases.

Also, according to the present invention, an amount and quality of contents provided to a broadcasting terminal are enhanced.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A data processing apparatus of a broadcasting terminal in a digital multimedia broadcasting system, the apparatus comprising:
an element for receiving broadcasting website service contained in digital multimedia broadcasting;
an element for storing a received webpage file;
an element for analyzing the received webpage file and providing the analyzed webpage file to a subscriber;
an element for selecting a predetermined media entity contained in the received webpage file; and
an element for transmitting the selected media entity to a counter party's terminal.

2. The apparatus according to claim 1, wherein the media entity is one of a video entity, an audio entity, and an image entity.

3. The apparatus according to claim 1, wherein the broadcasting website service uses a multimedia object transfer protocol.

4. The apparatus according to claim 1, wherein the media entity includes a relative path within a service webpage.

5. The apparatus according to claim 1, wherein the element for analyzing and providing the received webpage file comprises a web browser, and the web browser comprises a digital audio broadcasting gateway interface for tuning, service selection, and a volume control.

6. The apparatus according to claim 1, wherein the webpage file comprises a hypertext markup language.

7. The apparatus according to claim 1, wherein the element for transmitting the selected media entity transmits a data burst message in order to transmit the selected media entity.

8. A data processing apparatus of a broadcasting terminal in a digital multimedia broadcasting system, the apparatus comprising:
an element for displaying a webpage file received via broadcasting website service;
an element for selecting a media entity contained in the displayed webpage file; and
an element for transmitting the selected media entity to a reception party using an identification data of the reception party.

9. The apparatus according to claim 8, wherein the media entity uses an uniform resource locator designated on each of received webpage files.

10. The apparatus according to claim 8, wherein the identification data of the reception party is a phone number of a terminal of a counter party.

11. The apparatus according to claim 8, wherein the identification data of the reception party is a website address of a counter party.

12. The apparatus according to claim 8, wherein the identification data of the reception party is an Internet protocol-based address of a counter party's terminal.

13. The apparatus according to claim 8, wherein the media entity is one of a video file, an audio file, and an image file.

14. The apparatus according to claim 8, further comprising an element for receiving desired service, and a service component from the broadcasting website service using a locator.

15. The apparatus according to claim 8, wherein the element for selecting the media entity provides an error message when a digital audio broadcasting gateway interface is used in a case where a terminal does not support the selected media entity.

16. A data processing method of a broadcasting terminal, the method comprising:
receiving broadcasting website service contained in the digital multimedia broadcasting;
analyzing and storing a received webpage file, and providing the analyzed webpage file to a subscriber;
selecting a predetermined media entity contained in the received webpage file; and
transmitting the selected media entity using an identification data of a counter party's terminal.

17. The method according to claim 16, wherein the media entity is one of a video entity, an audio entity, and an image entity.

18. The method according to claim 16, wherein the broadcasting website service uses a multimedia object transfer protocol.

19. The method according to claim 16, wherein the media entity includes relative paths between all entities within a service webpage.

20. The method according to claim 16, wherein a digital audio broadcasting gateway interface for tuning, service selection, and a volume control within the broadcasting website service is included.

21. The method according to claim 16, wherein the webpage file comprises a hyper text markup language.

22. The method according to claim 16, wherein the transmitting of the selected media entity comprises transmitting a data burst message using the selected media entity and identification data of a counter party.

23. A data processing method of a broadcasting terminal, the method comprising:
displaying a webpage file received via broadcasting website service;
selecting a media entity contained in one of the displayed webpage and a webpage file; and
transmitting one of the selected webpage and media entity to a reception party using an identification data of the reception party.

24. The method according to claim 23, wherein the media entity uses uniform resource locator designated on each of received webpage files.

25. The method according to claim 23, wherein the identification data of the reception party includes phone numbers of terminals of one or more counter parties.

26. The method according to claim 23, wherein the identification data of the reception party is a website address of a counter party.

27. The method according to claim 23, wherein the identification data of the reception party is an Internet protocol-based address of a counter party's terminal.

28. The method according to claim 23, wherein the media entity is one of a video file, an audio file, and an image file.

29. The method according to claim 23, further comprising receiving broadcasting website service contained in digital multimedia broadcasting, the receiving of the broadcasting website service receives desired service and a service component from the broadcasting website service using a locator.

30. A data processing method of a broadcasting terminal, the method comprising:
receiving a message containing a media entity;
storing and informing the received message; and
when a subscriber selects the received message, displaying a corresponding media entity.

31. The method according to claim 30, wherein the media entity is one of a video entity, an audio entity, and an image entity.

32. The method according to claim 30, wherein the message includes a text.

33. The method according to claim 30, wherein the message is a data burst message.

34. The method according to claim 30, wherein the media entity includes a uniform resource indicator indicating the media entity.

35. The method according to claim 30, wherein reproduction of one of a video entity and an audio entity among the displayed media entity is controlled by a subscriber.

36. The method according to claim 30, wherein the media entity is retransmitted to other terminal.

37. The method according to claim 30, wherein the media entity is stored as a user media file by a user's request.

38. The method according to claim 30, wherein an interface with the media entity's data is a digital audio broadcasting gateway interface.
